(19) United States
(12) Patent Application Publication
(10) Pub. No.: US 2025/0205860 A1
(43) Pub. Date: Jun. 26, 2025

(54) REACTION WASHER SYSTEM AND COMPACT REACTION WASHER

(71) Applicant: PRIMESOURCE CONSULTING LLC, Herriman, UT (US)

(72) Inventor: John Davis, Herriman, UT (US)

(21) Appl. No.: 18/394,372

(22) Filed: Dec. 22, 2023

(51) Int. Cl. B25B 23/00; B25B 21/00

(52) U.S. Cl. CPC B25B 23/0071; B25B 21/00

(57) ABSTRACT

A reaction socket assembly includes a socket configured to slidingly engage an associated nut so as to define a socket axis. The socket engages the associated nut for paired rotational movement. The reaction socket assembly also includes a lower part disposed coaxially exterior to the socket. The lower part defines a plurality of recesses and a plurality of keyways and the plurality of recesses are fluidly connected with the respective plurality of keyways. The reaction socket assembly also includes a plurality of keys selectively disposed in the plurality of recesses and the plurality of keyways and a sleeve disposed coaxially exterior to the lower part. The sleeve includes a plurality of ramps that are selectively received in the plurality of recesses.

### BACKGROUND

Power driven torque tools generate an accurate bolt load through the rotation of a fastener. A reaction washer can be used to provide an abutment means for the tool. In particular, the reaction washer is placed directly below the nut or bolt head being subjected to the intended tightening force. Further, the reaction washer is connected to the tool housing via a reaction socket assembly. This connection ensures that the tightening force generated by the tool is transferred into the fastener and does not merely result in rotation of the tool around the axis of the fastener.

However, there are difficulties associated with these tools and traditional reaction washers. For example, the reaction washer and reaction socket assembly may need to be used in a horizontal or inverted position. When these orientations are present, the connection between the reaction washer and reaction socket can be compromised. Traditional reaction washers do not provide a positive connection means to the reaction socket allowing for a safe, hands-free operation of the power driven torque tool. Further, the reaction socket might not mate with the corresponding power-driven torque tool due to connection differences between the power driven torque tool body and the receiving end of the reaction socket. Furthermore, many reaction washers do not sufficiently engage with the reaction socket assembly thus inducing damage to the reaction washer, requiring the reaction washer to be deemed a single use item. As such, a better system and washer are needed.

### SUMMARY

According to an aspect, a reaction socket assembly includes a socket configured to slidingly engage an associated nut or bolt head so as to define a socket axis. The socket engages the associated nut for paired rotational movement. The reaction socket assembly also includes a lower part disposed coaxially exterior to the socket.

The lower part defines a plurality of recesses and a plurality of keyways and the plurality of recesses are fluidly connected with the respective plurality of keyways. The reaction socket assembly also includes a plurality of keys selectively disposed in the plurality of recesses and the plurality of keyways and a sleeve disposed coaxially exterior to the lower part. The sleeve includes a plurality of ramps that are selectively received in the plurality of recesses.

According to an aspect, a compact reaction washer includes a main body that defines an inner diameter that slidingly receives an associated threaded element therethrough so as to define a socket axis. The main body includes a first face and a second face that face in opposite directions that cooperate to define a washer thickness and a perimeter face that faces radially away from the socket axis.

The main body further includes an engagement ring having a plurality of serrations extending from the first face. The perimeter face defines a plurality of locking elements that are located at least partially within the main body. The plurality of locking elements define a plurality of locking element axes that pass through the respective plurality of locking elements so as to extend between the first face and the second face while being orthogonal to the socket axis.

### BRIEF DESCRIPTION OF THE DRAWINGS

FIG. 1 is a perspective view of a reaction washer assembly and compact reaction washer in an operating environment;

FIG. 2 is an exploded perspective view of the reaction washer assembly of FIG. 1;

FIG. 3A is a sectional view of the reaction washer and the reaction socket assembly with the reaction socket in an engaged position;

FIG. 3B is a sectional view of the reaction washer and reaction socket assembly with the reaction socket in an unengaged position;

FIG. 4 is a partial sectional view of the reaction washer assembly;

FIG. 5 is a top plan view of the compact reaction washer;

FIG. 6 is a bottom plan view of the compact reaction washer;

FIG. 7 is a perspective view of the compact reaction washer;

FIG. 8A is an elevation view of the compact reaction washer; and

FIG. 8B is an enlarged view of a portion of the compact reaction washer of FIG. 8A.

### DETAILED DESCRIPTION

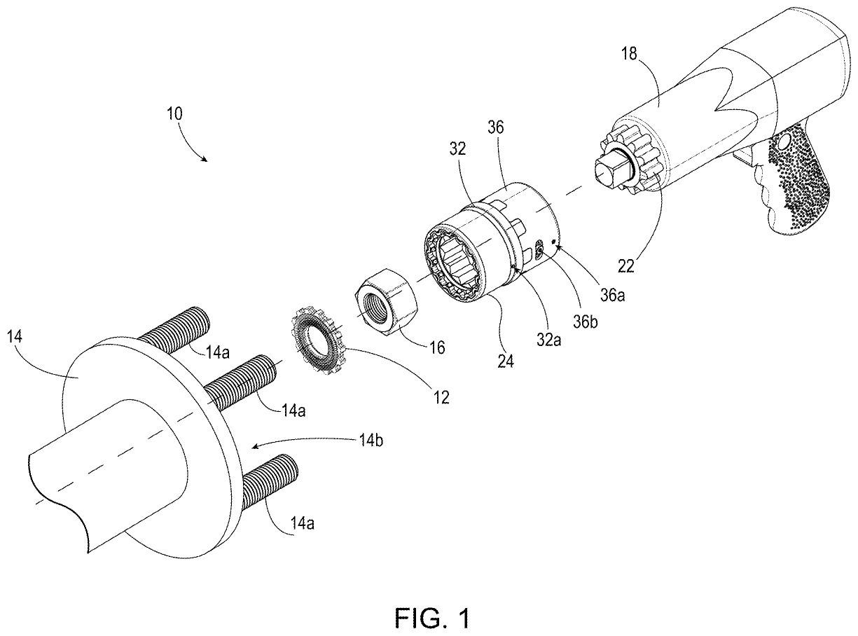

With reference to FIG. 1, a reaction socket assembly 10 can be used with a variety of components to engage a compact reaction washer 12 that is slidingly received on associated threaded element 14a that contacts a flange face 14b of a flange assembly 14 and an associated nut 16 that is threadingly received on the associated threaded element 14a.

As illustrated, the reaction socket assembly 10 can be used with an associated torque tool 18 that includes an engagement point 22 to engage the compact reaction washer 12 and nut 16. The threaded element 14a could be part of a bolt or stud that is threadingly engaged by the nut 16. The compact reaction washer 12 is disposed on the threaded element 14a so that the nut 16 is between the compact reaction washer 12 and the free end of the threaded element 14a along the socket axis 38 so as to engage the torque tool 18 as will be described in more detail hereinafter.

Notably, the compact reaction washer 12 can slidingly and coaxially receive the threaded element 14a and the nut 16 can threadingly and coaxially receive the threaded element 14a, both along the socket axis 38. As noted hereinbefore, the torque tool 18 can be utilized to tighten or loosen the nut 16. As will be appreciated, this means that the nut 16 would travel along the threaded element 14a toward the free end of the threaded element 14a when the nut 16 is being loosened so that the nut 16 could be removed from the threaded element 14a and the nut 16 would travel along the threaded element 14a away from the free end of the threaded element 14a when the associated threaded element 14a is being tightened so that the nut 16 cannot be removed from the threaded element 14a.

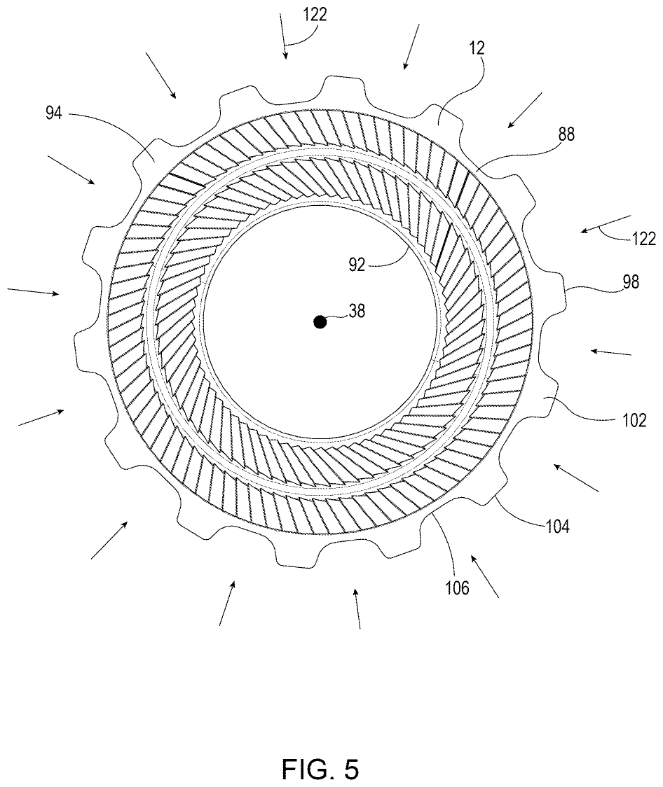

The flange 14 either receives or is attached to the threaded element 14a distal to the free end so as to provide a surface to which the compact reaction washer 12 and the nut 16 can be tightened (i.e., preventing linear movement of the compact reaction washer 12 and the nut 16 along the socket axis 38 away from the free end). Further, as will be described in more detail hereinafter, serrations 112 (FIG. 5) of the compact reaction washer 12 prevent rotation of the compact reaction washer 12 around the threaded element 14a.

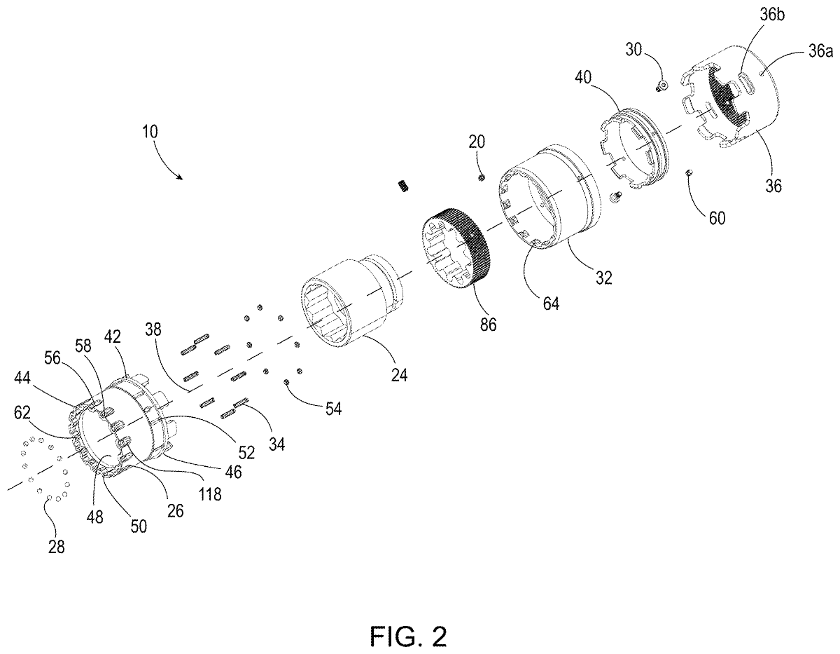

As shown in FIG. 2, the reaction socket assembly 10 includes the socket 24, a lower part 26, a plurality of keys 28, and a sleeve 32. Additionally, the reaction socket assembly 10 can also include at least one resiliently resistive element 34, a drive cap 36, and an insert 40.

The socket 24 is configured to slidingly engage the associated nut 16 so as to define a socket axis 38. As will be appreciated, the socket 24 would rotate about the socket axis 38 when driven by the torque tool 18. As such, the socket 24 engages the associated nut 16 for paired rotational movement. The socket 24 is configured to rotationally move independent of the lower part 26. As illustrated, the socket 24 defines a generally cylindrical outer diameter and is a 12-point socket. However, it will be appreciated that other shapes are possible and contemplated without departing from the scope of this disclosure.

The lower part 26 can be disposed coaxially exterior to the socket 24. The lower part 26 can have a generally cylindrical shape with a top 42 and a bottom 44 disposed at opposite ends thereof along the socket axis 38. The lower part 26 can also include a lip 46 that circumferentially extends around the top 42 of the lower part 26.

The lower part 26 can define a lower part inner diameter surface 48 and a plurality of slots 50. The slots 50 can extend primarily in a direction parallel to the socket axis 38. Further, the slots 50 can be disposed within the lower part 26 and adjacent the bottom 44 of the lower part 26. The slots 50 can extend from the bottom 44 toward the top 42.

It is envisioned that the slots 50 will only extend partially upward toward the top 42 a distance that is approximately equal to the thickness of the compact reaction washer 12. However, it will be appreciated that that the length of the slots 50 could be of a variety of lengths without departing from the scope of this disclosure. As will be described in more detail hereinafter, the slots 50 of the lower part 26 engage the lobes 102 of the compact reaction washer 12. This engagement provides for improved operation of the compact reaction washer 12 and the reaction socket assembly 10. Notably, the locking elements 118 and the lobes 102 load share a rotational force induced into the compact reaction washer 12 so as to provide a major diameter load distribution and a minor diameter load distribution of forces.

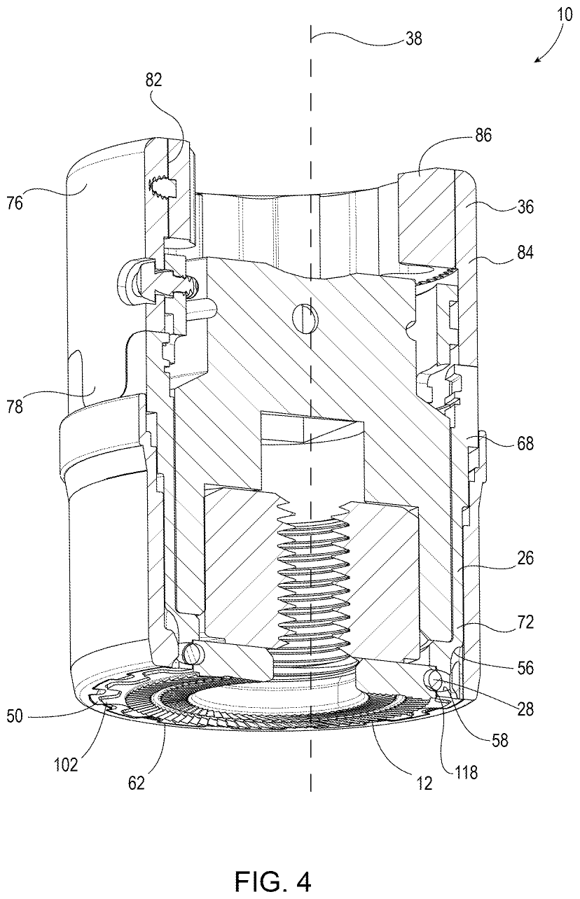

As shown in FIG. 4, the slots 50 of the lower part 26 can engage the compact reaction washer 12. The lower part 26 can also define a plurality of open channels 52 that extend in a direction generally parallel to the socket axis 38 for receipt of the least one resistive element 34. As will be appreciated, the open channels 52 are sized to allow at least partial receipt of the at least one resistive element 34. Notably, the open channels 52 can be sized such that a radial portion of the resistive element 34 is not received within the open channels 52 so that the sleeve 32 and the lower part 26 can be biased away from one another. The at least one resistive element 34 can be retained within the open channels 52 with a cover 54 that may be threaded or otherwise affixed to the lower part 26.

The lower part 26 can also define a plurality of recesses 56 and a plurality of keyways 58. As illustrated, the recesses 56 and keyways 58 are disposed near the bottom 44 of the lower part 26 and are radially disposed about the lower part 26. Further, the recesses 56 can extend primarily in a direction parallel to the socket axis 38 and the keyways 58 can extend primarily in a direction radially extending toward the socket axis 38.

The plurality of recesses 56 are fluidly connected with the respective plurality of keyways 58. Additionally, the plurality of keyways 58 fluidically connect the sleeve 32 and the socket 24. The lower part inner diameter surface 48 defines a plurality of engagement ports 62 in direct fluid communication with the respective keyways 58. More particularly, the engagement ports 62 can serve as a fluidic gateway to the keyways 58. Further, the engagement ports 62 can be sized to limit radial travel of the keys 28 toward the socket axis 38.

As illustrated, the keys 28 are generally spherical in shape. The spherical shape allows the keys 28 to smoothly and precisely move within the recesses 56 and the keyways 58 for enhanced engagement with the compact reaction washer 12. However, it will be appreciated that other shapes are possible without departing from the scope of the disclosure. As will be discussed in more detail hereinafter, the plurality of keys 28 can at least partially extend radially inward toward the socket axis 38 when a respective plurality of ramps 64 of the sleeve 32 are received in the respective plurality of recesses 56 of the lower part 26. However, as was previously noted, the size of the engagement ports 62 limit the radial movement of the keys 28 toward the socket axis 38.

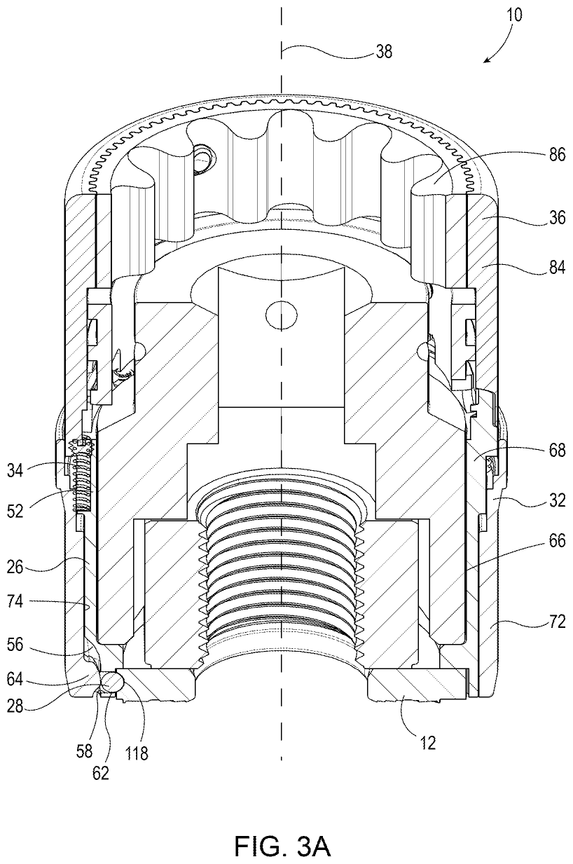

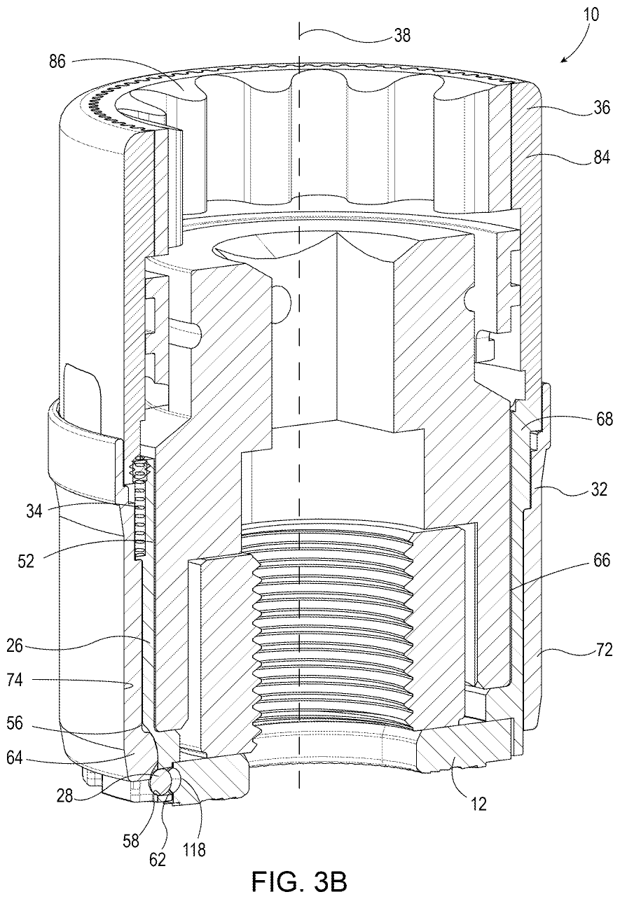

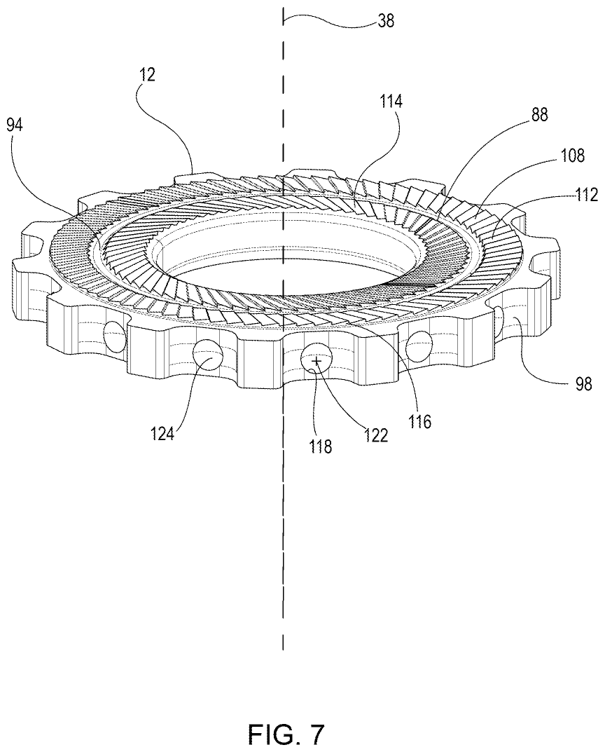

As shown in FIG. 3, the plurality of keys 28 are selectively disposed in the plurality of recesses 56 and the plurality of keyways 58. The lower part 26 and the plurality of keys 28 are configured to simultaneously engage the compact reaction washer 12 so as to prevent rotation about the socket axis 38 between the lower part 26, the plurality of keys 28, and the associated compact reaction washer 12. Notably, as will be described hereinafter, the keys 28 engage locking elements 118 (FIG. 7) of the compact reaction washer 12.

The sleeve 32 can be disposed coaxially exterior to the lower part 26. The sleeve 32 can be of a generally cylindrical shape and include the plurality of ramps 64 that are selectively received in the plurality of recesses 56. The sleeve 32 can define a sleeve inner diameter surface 66 from which the plurality of ramps 64 radially extend inward. The sleeve 32 can define a sleeve bore 32a that allows passage of a set screw 60 therethrough for engagement with the insert 40. As illustrated, there are a plurality of sleeve bores 32a and they radially extend through the sleeve 32 toward the socket axis 38. This engagement ensures that the lower part 26 and the sleeve 32 remain attached to one another.

Further, the sleeve 32 can include a first end 68 and a second end 72. The first end 68 and the second end 72 can be disposed at opposite ends of the sleeve 32. Additionally, the second end 72 of the sleeve 32 can define a second end inner diameter surface 74 that circumferentially surrounds the lower part 26. The second end inner diameter surface 74 can define a sleeve shape and a sleeve size.

The reaction socket assembly 10 can define an engaged position when the respective plurality of ramps 64 of the sleeve 32 are received in the respective plurality of recesses 56 of the lower part 26 and an unengaged position when the respective plurality of ramps 64 of the sleeve 32 are not received in the respective plurality of recesses 56 of the lower part 26. In the engaged position, the keys 28 at least partially extend through the keyways 58, and more particularly through the engagement ports 62 toward the socket axis 28. Thus, the keys 28 can be at least partially received in, and engage, the locking elements 118 of the compact reaction washer 12. Further, the engaged position provide for a hands-free connection between the associated compact reaction washer 12 and the reaction socket assembly 10. In contrast, in the unengaged position, the keys 28 do not extend through the engagement ports 62 toward the socket axis 28. Thus, the keys 28 are not received in, and do not engage, the locking elements 118 of the compact reaction washer 12.

The at least one resiliently resistive element 34 can be disposed between the sleeve 32 and the lower part 26. As noted hereinbefore, the at least one resistive element 34 can be received in the open channels 52. As illustrated, there are a plurality of resistive elements 34. Further, the resistive elements 34 are shown as coil springs. However, it will be appreciated that other types of resistive elements are possible and contemplated without departing from the scope of the disclosure. Functionally, the resistive element 34 can bias the sleeve 32 and the lower part 26 away from one another along the socket axis 38 for improved operation of the reaction socket assembly 10.

As shown in FIG. 4, the drive cap 36 can be configured for engagement with the associated torque tool 18 such that the drive cap 36 does not spin with respect to the engagement point 22 of the associated torque tool 18. The drive cap 36 can have a generally cylindrical shape.

With reference to FIGS. 1-2, the drive cap 36 can define an upper set screw bore 36a that allows passage of a set screw 20 therethrough for engagement with the locking sleeve 40. As illustrated, there are a plurality of upper set screw bores 36a and they radially extend through the drive cap 36 toward the socket axis 38. This engagement ensures that the drive cap 36 and the insert 86 remain attached to one another.

The drive cap 36 can also define a cap slot 36b that allows passage of shoulder bolt 30 therethrough for engagement with the locking sleeve 40. There can include a single or a plurality of cap slots 36b, and hence a single or a plurality of shoulder bolts 30, without departing from the scope of the disclosure. This engagement ensures that the drive cap 36 and the locking sleeve 40 remain attached to one another.

The drive cap 36 can include an upper end 76 and a lower end 78 disposed at opposite ends. The lower end 78 is adjacent the sleeve 32 and the first end 68 is adjacent the lower end 78. The upper end 76 of the drive cap 36 and the second end 72 of the sleeve 32 are disposed at opposite ends of the reaction socket assembly 10 so as to define terminal ends of the reaction socket assembly 10.

The upper end 76 of the drive cap 36 can define an upper inner diameter surface 82 that slidingly engages the associated torque tool 18 to prevent rotation of the drive cap 36 with respect to the associated torque tool 18. The upper inner diameter surface 82 can define an upper cap shape and an upper cap size.

The upper cap shape and the upper cap size can be the same as the sleeve shape and the sleeve size, respectively. As illustrated, the drive cap 36 includes a primary portion 84 and an insert 86. The insert 86 can be circumferentially surrounded by the primary portion 84, with the insert 86 and the primary portion 84 being connected to one another via a splined connection. The insert 86 can be removed and replaced by other differing interior geometry inserts to match the connection geometry of other tool housings. Thus, the upper inner diameter surface 82 can receive a variety of inserts 86 to allow compatibility with different torque tool brands.

The reaction socket assembly 10 provides numerous advantages. For example, the reaction socket assembly 10 allows the torque tool 18 to be used in a variety of orientations that would otherwise not be possible. Notably, there are several environments in which the torque tool 18 could not be safely used when the fastener assembly is inverted. Such orientation would require the user to manually hold the torque tool 18 and reaction socket assembly 10 flush against the reaction washer 12 to maintain sufficient mating. Additional limitations can occur when the torque tool 18 and reaction socket assembly 10 are placed horizontally against the face of the reaction washer 12. With the weight of larger versions of the torque tool 18 and reaction socket assembly 10 exceeding 100 pounds, the ability to maintain a perpendicular orientation to the flange face and reaction washer 12 can cause the engagement of the reaction socket assembly 10 and reaction washer 12 to become misaligned and only partially engaged, thus damaging the reaction washer 12 and reaction socket assembly 10.

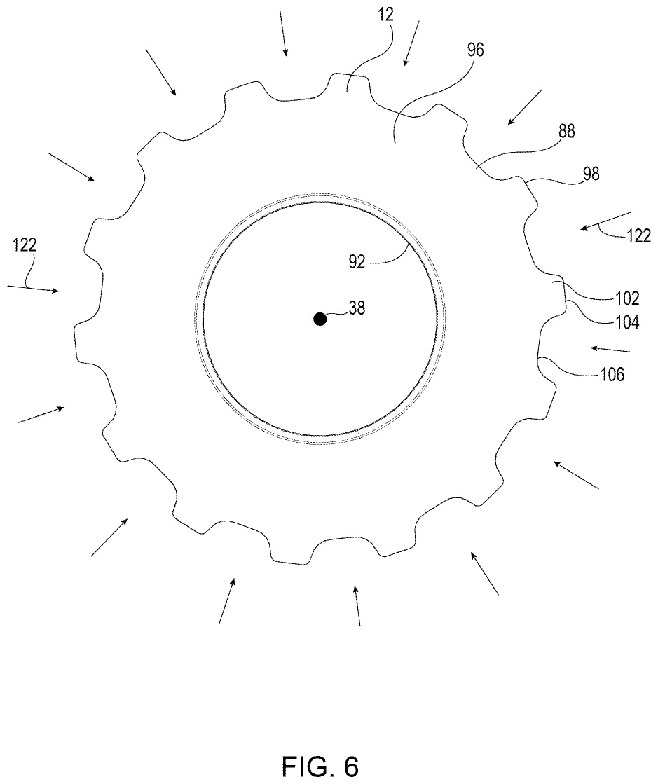

As shown in FIG. 5, the compact reaction washer 12 can include a main body 88 that defines an inner diameter surface 92 that slidingly receives the threaded element 14a therethrough so as to define the socket axis 38. The main body 88 can include a first face 94 and a second face 96 (FIG. 6) that face in opposite directions that cooperate to define a washer thickness. The main body 88 can also include a perimeter face 98 that faces radially away from the socket axis 38. A distance between the first face 94 and the second face 96 can remain constant when extending radially outward from the inner diameter surface 92 to the perimeter face 98.

The main body 88 can include a plurality of lobes 102. Each of the lobes 102 can include a peak 104 that defines a respective maximum radial distance from the socket axis 38 and a valley 106 that defines a respective minimum radial distance from the socket axis 38. As shown in FIG. 4, the lobes 102 can engage with the lower part 26 of the torque tool 18 to prevent rotation between the compact reaction washer 12 and the lower part 26 of the torque tool 18.

With reference to FIG. 7, the main body 88 can also include an engagement ring 108 having a plurality of serrations 112 extending from the first face 94. There can be one or more engagement rings extending from the main body 88 without departing from the scope of the disclosure. For example, the main body 88 can include the engagement ring 108 and a secondary engagement ring 114. As illustrated, the secondary engagement ring 114 is disposed radially inward from engagement ring 108. The serrations 112 prevent slipping and allow for effective transfer of reaction torque onto the surface (i.e., flange face 14b) onto which the nut 16 is being tightened. Because of the serrations 112, the compact reaction washer 12 will not slip and spin when the torque tool 18 starts to apply torque to the nut 16 and/or bolt head while withholding itself via the socket 24 on the compact reaction washer 12.

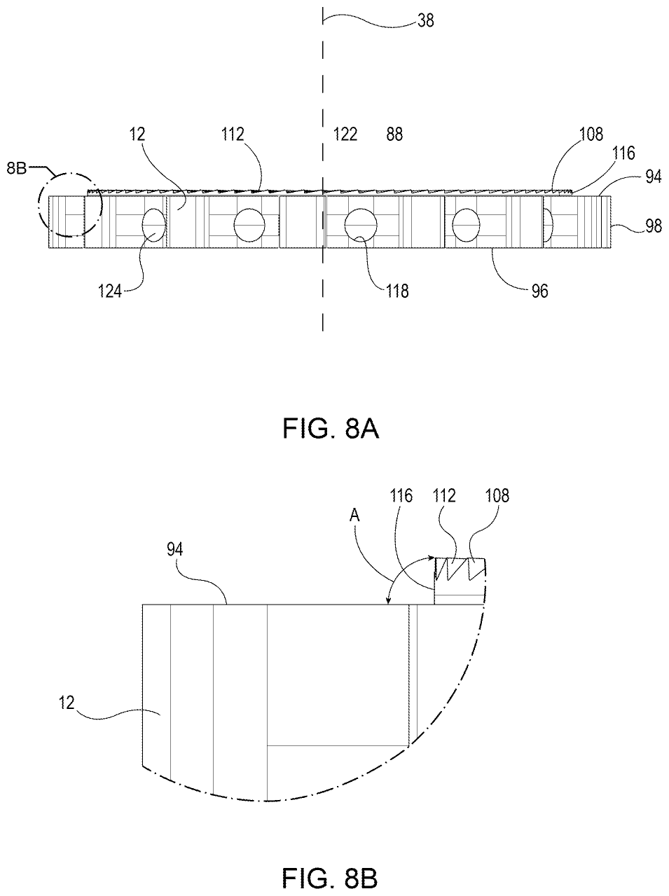

As shown in FIGS. 8A and 8B, the engagement ring 108 can include an engagement ring outer diameter surface 116 that defines an engagement ring outer diameter. The plurality of serrations 112 can extend from the first face 94 such that an included angle A between the engagement ring outer diameter surface 116 and the first face 94 is equal to 90 degrees. This non-tapered arrangement provides for improved engagement between the compact reaction washer 12 and the mating surface of the flange or other element to which contact is made.

Referring back to FIGS. 7 and 8A, the perimeter face 98 can define a plurality of locking elements 118 that can be located at least partially within the main body 88. The plurality of locking elements 118 can define a plurality of locking element axes 122 that pass through the respective plurality of locking elements 118 so as to extend between the first face 94 and the second face 96 while being orthogonal to the socket axis 38. Further, the plurality of locking element axes 122 can also intersect the socket axis 38 while extending between the first face 94 and the second face 96. The locking elements 118 are configured to provide an additional method of engagement between the compact reaction washer 12 and the torque tool 18.

The plurality of locking elements 118 can be at least partially obscured when viewing the compact reaction washer 12 in plan view in a direction along the socket axis 38. Alternatively, the plurality of locking elements 118 can be completely unviewable when viewing the compact reaction washer 12 in plan view in a direction along the socket axis 38. By being recessed, the locking elements 118 provide a smooth profile for the compact reaction washer 12 to simply installation on the threaded element 14a and also during subsequent usage.

The plurality of locking elements 118 can each define a curved concave surface 124 that is not coaxial with an area of the perimeter face 98 that is adjacent the respective locking element 118. Further, the respective curved concave surface 124 is curved about the respective locking element axis 122. This shape allows for easy and sturdy receipt of the keys 28 that extend through the engagement ports 62 of the lower part 26 of the reaction socket assembly 10.

With continued attention to FIGS. 7 and 8A, one of the locking elements 118 of the plurality of locking elements 118 can be located in the perimeter face 98 at one of the valleys 106 of the plurality of lobes 102. Further, two of the locking elements 118 of the plurality of locking elements 118 can be separated by one of the peaks 104 of one of the lobes 102. By locating the locking elements 118 in this manner, a dual-drive system that simultaneously provides two different ways of engagement between the compact reaction washer 12 and the reaction socket assembly 10 is provided.

Firstly, the locking element 118 of the compact reaction washer 12 engages with the key 28 that extends through the engagement port 62 of the lower part 26 of the reaction socket assembly 10. Secondly, the peak 104 of the lobe 102 engages with the slot 50 of the lower part 26 of the reaction socket assembly 10. As will be appreciated, this provides a robust connection that better distributes loads throughout the components.

As illustrated, the locking elements 118 are curved concave surfaces so as to receive the keys 28. However, it will be appreciated that this arrangement could be reversed without departing from the scope of the disclosure. In particular, the locking elements 118 could be convexly shaped and extend into the engagement ports 62 to provide a secure connection between the compact reaction washer 12 and the reaction socket assembly 10.

A reaction washer system and compact reaction washer have been described above with particularity. Modifications and alterations will occur to those upon reading and understanding the preceding detailed description. The invention, however, is not limited to only the embodiments described above. Instead, the invention is broadly defined by the appended claims and the equivalents thereof.

1. A reaction socket assembly, comprising:
a socket configured to slidingly engage an associated nut so as to define a socket axis, wherein the socket engages the associated nut for paired rotational movement;
a lower part disposed coaxially exterior to the socket, the lower part defining a plurality of recesses and a plurality of keyways, wherein the plurality of recesses are fluidly connected with the respective plurality of keyways;
a plurality of keys selectively disposed in the plurality of recesses and the plurality of keyways; and
a sleeve disposed coaxially exterior to the lower part, the sleeve including a plurality of ramps that are selectively received in the plurality of recesses.

2. The reaction socket assembly of claim 1, wherein the reaction socket assembly defines an engaged position when the respective plurality of ramps of the sleeve are received in the respective plurality of recesses of the lower part so as to bias the plurality of keys toward the socket axis and an unengaged position when the respective plurality of ramps of the sleeve are not received in the respective plurality of recesses of the lower part so that the plurality of keys are not biased toward the socket axis.

3. The reaction socket assembly of claim 1, wherein the plurality of keyways fluidically connect the sleeve and the socket.

4. The reaction socket assembly of claim 1, wherein the sleeve defines a sleeve inner diameter surface from which the plurality of ramps radially extend inward and the lower part defines a lower part inner diameter surface.

5. The reaction socket assembly of claim 4, wherein the lower part defines a lower part inner diameter surface that defines a plurality of engagement ports in direct fluid communication with the respective keyways, wherein the plurality of keys at least partially extend radially inward toward the socket axis when the respective plurality of ramps of the sleeve are received in the respective plurality of recesses of the lower part.

6. The reaction socket assembly of claim 1, further comprising at least one resiliently resistive element disposed between the sleeve and the lower part, the resistive element biasing the sleeve and the lower part away from one another along the socket axis.

7. The reaction socket assembly of claim 2, further comprising a drive cap configured for engagement with an associated torque tool such that the drive cap does not spin with respect to an engagement point of the associated torque tool.

8. The reaction socket assembly of claim 7, wherein the drive cap includes an upper end and a lower end disposed at opposite ends of the drive cap, the lower end adjacent the sleeve, wherein the sleeve includes a first end and a second end, the first end being adjacent the lower end, and wherein the upper end of the drive cap and the second end of the sleeve are disposed at opposite ends of the reaction socket assembly so as to define terminal ends of the reaction socket assembly.

9. The reaction socket assembly of claim 8, wherein the upper end of the drive cap defines an upper inner diameter surface that slidingly engages the associated torque tool to prevent rotation of the drive cap with respect to the associated torque tool and the second end of the sleeve defines a second end inner diameter surface that circumferentially surrounds the lower part.

10. The reaction socket assembly of claim 9, wherein the upper inner diameter surface defines an upper cap shape and an upper cap size and the second end inner diameter surface define a sleeve shape and a sleeve size, and wherein the upper cap shape and the upper cap size are the same as the sleeve shape and the sleeve size, respectively.

11. The reaction socket assembly of claim 2, wherein the socket is configured to rotationally move independent of the lower part.

12. The reaction socket assembly of claim 1, wherein the lower part and the plurality of keys are configured to simultaneously engage an associated compact reaction washer so as to prevent rotation between the lower part, the plurality of keys, and the associated compact reaction washer.

13. The reaction socket assembly of claim 2, wherein the engaged position provide for a hands-free connection between an associated compact reaction washer and the reaction socket assembly.

14. A compact reaction washer, comprising:
a main body defining an inner diameter that slidingly receives an associated threaded element therethrough so as to define a socket axis, the main body including a first face and a second face that face in opposite directions that cooperate to define a washer thickness and a perimeter face that faces radially away from the socket axis, the main body further including an engagement ring having a plurality of serrations extending from the first face, wherein the perimeter face defines a plurality of locking elements that are located at least partially within the main body, and wherein the plurality of locking elements define a plurality of locking element axes that pass through the respective plurality of locking elements so as to extend between the first face and the second face while being orthogonal to the socket axis.

15. The compact reaction washer of claim 14, wherein the plurality of locking elements are at least partially obscured when viewing the compact reaction washer in plan view in a direction along the socket axis.

16. The compact reaction washer of claim 15, wherein the plurality of locking elements are not viewable when viewing the compact reaction washer in plan view in a direction along the socket axis.

17. The compact reaction washer of claim 14, wherein the plurality of locking elements each define a curved concave surface that is not coaxial with an area of the perimeter face of the main body that is adjacent the respective locking element.

18. The compact reaction washer of claim 17, wherein the respective curved concave surfaces of the plurality of locking elements are curved about the respective locking element axes.

19. The compact reaction washer of claim 14, wherein a distance between the first face of the main body and the second face of the main body remains constant when extending radially outward from the inner diameter to the perimeter face.

20. The compact reaction washer of claim 14, the main body including a plurality of lobes, wherein each of the lobes include a peak that defines a respective maximum radial distance from the socket axis and a valley that defines a respective minimum radial distance from the socket axis.

21. The compact reaction washer of claim 20, wherein one of the locking elements of the plurality of locking elements is located in the perimeter face at one of the valleys of the plurality of lobes.

22. The compact reaction washer of claim 20, wherein two of the locking elements of the plurality of locking elements are separated by one of the peaks of one of the lobes.

23. The compact reaction washer of claim 14, wherein the engagement ring includes an engagement ring outer diameter surface that defines an engagement ring outer diameter, wherein the plurality of serrations extend from the first face such that an included angle between the engagement ring outer diameter surface and the first face is equal to 90 degrees.

24. The compact reaction washer of claim 14, wherein the plurality of locking element axes also intersect the socket axis while extending between the first face of the main body and the second face of the main body.

25. The compact reaction washer of claim 20, wherein the locking elements and the lobes load share a rotational force induced into the compact reaction washer so as to provide a major diameter load distribution and a minor diameter load distribution of forces.
